(19) United States
(12) Patent Application Publication
(10) Pub. No.: US 2008/0000083 A1
(43) Pub. Date: Jan. 3, 2008

(54) PROCESS FOR LINING A FLUID HELICAL DEVICE STATOR

(76) Inventor: Steven M. Wood, Tulsa, OK (US)

Correspondence Address: HEAD, JOHNSON & KACHIGIAN, 228 W 17TH PLACE, TULSA, OK, 74119, US

(21) Appl. No.: 10/907,634

(22) Filed: Apr. 8, 2005

(51) Int. Cl. B23P 15/04; B23P 25/00

(52) U.S. Cl. 29/889.22; 29/458

(57) ABSTRACT

A process for lining or for relining a fluid helical device stator. In one preferred embodiment, the process includes removing an existing helical surface of a progressive cavity helical device from a housing which is connected to tubulars used downhole in a subterranean well. A mandrel having a helical exterior is inserted into a mold. In one preferred embodiment, a composite stator insert is formed in the mold composed of fibers and resin. Once the composite stator insert has been formed, the mandrel and the mold are removed. The composite stator insert is inserted into and attached to the housing.

### BACKGROUND OF THE INVENTION

1. Field of the Invention

The present invention is directed to a process or method of lining or retrofitting a stator of a cylindrical power section or pump helical device. More particularly, the present invention is directed to a process or method to more economically manufacture a new stator or remanufacture an existing stator of a progressive cavity helical device using a liner as a stator insert.

2. Prior Art

Various types of downhole progressive cavity motors and pumps have been utilized in the past. When a helical rotor/stator combination is used to lift fluid, it is a pump. When a rotor is turned with induced pressure (hydraulic being one form), then it is a motor. The hydraulic motors convert a portion of fluid hydraulic energy into mechanical energy in the form of torque and/or rotational speed. In one type of downhole progressive cavity motor, drilling fluid or drilling mud is pumped from the surface down to a subterranean helical rotor/stator combination known as a power section.

The power section is the heart of a hydraulic progressive cavity motor. It is responsible for converting hydraulic energy in the form of flow and pressure into mechanical energy which the motor outputs as torque and rotational speed. The progressive cavity device of the power section includes both a rotor and a stator. The helical rotor is the innermost component and is often the rotating component, although this is not always the case. The rotor contains one less lobe than its mating stator. The stator includes a steel tube which may be lined with an elastomeric material or rubber to form the helical shape. The steel stator tube is the component of the assembly that bears the tension, torsion and compression exerted on the downhole assembly by the pipe string and action of the rotational forces from drilling or pumping. These forces can be extreme in the case of deep well drilling or production. To be deployed into service these embodiments have high grade proprietary threads cut in the steel stator tube ends which connect to a drill string or production tubing. The metals selected for the tube may be premium grades for the extreme applications anticipated.

The stators are generally of a number of different types. There are elastomer stators which are bonded and formed to an outer metal cylinder as well as stators produced by machining a metal cylindrical block or heavy wall tube of sufficient thickness to form the stator I.D dimensions. Other types are made by bending a cylindrical tube using hydro-forming or high pressure extrusion; or by metal casting the helix shape using conventional metal casting processes. If a good fit is not maintained between the rotor and stator, wear and other performance issues arise. For fit and performance reasons all but the all elastomeric embodiments coat the inner stator wall with an elastomeric coating of even thickness. In all but the first embodiment, the metal machined or formed must be designed of sufficient cross section to withstand the tension, torque and compression of the application and becomes the tube. This design requirement prevents more cost effective manufacturing and forever couples the function of the tube with the function of the helical component.

The helical device of the present invention is intended to operate with various fluids, including liquids and gases. One type of progressive cavity device is shown in Applicant=s U.S. Pat. No. 6,461,128.

In all cases, it is known that the stators tend to wear over time and must be refurbished or replaced. The average run time for power section stators is approximately 250-350 hours before replacement is necessary.

Refurbishment or replacement now takes place by shipping the components from the field to a remanufacturing facility where the helical forming cores reside.

It would be desirable to have a method of lining or remanufacturing where the function of the tube to provide tension, compression, and torque resistance along with retaining proprietary threads and premium high cost metals can be segregated from the function of forming the helical stator in all embodiments.

It would be advantageous to have a replaceable insert containing a helical wear element, since the wear element has a life many times less than the usable life of the stator steel tube.

It would be advantageous to provide a replaceable stator insert that could be replaced in a location near the point of use.

It would be desirable to provide a replaceable insert for a steel stator tube that may be precisely manufactured to desirable tolerances and then inserted and attached to the interior walls of a steel stator tube of a power section or pump.

It would be advantageous to provide formed metal helicals whose design does not require functionality as a drilling or production tubular.

It would be desirable to provide a process to reline or retrofit existing power sections or pumps with an helical insert having wear characteristics greater than those now existing.

### SUMMARY OF THE INVENTION

The present invention is directed to a process to line or to remanufacture/reline a fluid helical device stator. In one example of a preferred embodiment of the invention, a metal cylindrical housing of a power section or pump is brought to the surface. An existing stator is removed from the cylindrical housing in a number of ways. The existing stator may be machined or ground out from the cylindrical housing or a chemical agent may be utilized to remove the existing stator.

Independent of the removal of the existing stator, a stator insert is produced. A mandrel having helical exterior surfaces inserted into a mold having an internal cylindrical form. The mandrel is inserted into the mold so that it is centralized and coaxial with the mold. Various materials may be utilized for the insert. Composite materials that are infused or impregnated with a resin would be one method. Once the composite stator insert is cured or otherwise hardened in the mold, the first mandrel is removed from the insert.

If an elastomeric lining is desired, a smaller diameter, second mandrel with the desired dimensions of the finished stator is then inserted into the mold. An inner lining acting as a sealing membrane is formed in the space between the exterior of the second mandrel and the helical surface of the composite insert. Finally, the insert with the inner lining is removed from the mold. The outer cylindrical surface of the composite insert has a diameter slightly less than the interior diameter of the cylindrical housing of the power section. Finally, the composite stator insert is inserted into the housing and attached thereto by bonding or mechanically locking in place.

Another alternate method of the present invention includes the steps of forming a stator insert from a metal cylinder resulting in a helical internal surface. Thereafter, the helical internal surface may optionally be lined with an elastomeric lining. The stator insert is then placed in the cylindrical housing. The space between the stator insert and the cylindrical housing is then back filled and the insert is attached to the cylindrical housing.

### BRIEF DESCRIPTION OF THE DRAWINGS

FIG. 1 is a diagrammatic flow chart illustrating one preferred method of relining a fluid helical device stator;

FIGS. 2 through 10 illustrate sequential views of the process to reline a fluid helical device stator as set forth in the present invention;

FIGS. 11 and 12 illustrate cross-sectional views of a relined fluid helical device stator produced as set forth in FIGS. 1 through 10;

FIG. 13 illustrates a perspective view of a portion of a stator insert of an alternate embodiment of a relined fluid helical device stator;

FIG. 14 illustrates a perspective view of the stator insert shown in FIG. 13 being inserted into a cylindrical housing;

FIGS. 15 and 16 illustrate cross-sectional views of the alternate embodiment of a relined fluid helical device stator shown in FIGS. 13 and 14; and

FIG. 17 is a diagrammatic flow chart illustrating an alternate preferred method of relining a fluid helical device stator as shown in FIGS. 13 and 14.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

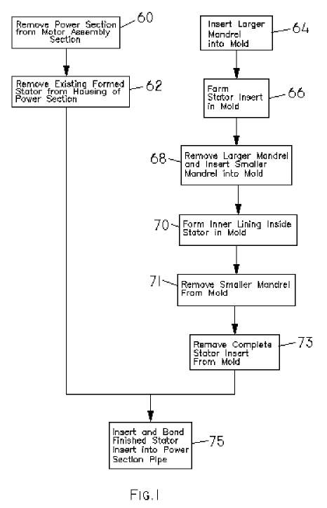

FIG. 1 illustrates a simplified flow chart of a first, preferred process or method to utilize and employ the present invention. Initially, a power section which operates downhole in a subterranean well and is connected to production tubing is brought to the surface as shown by box 60.

The power section includes a portion having a cylindrical housing. The cylindrical housing is typically made of a sturdy metal material. The existing stator is formed within the interior of the cylindrical housing. The existing stator is removed from the cylindrical housing as shown at box 62 in one of a number of ways. The existing stator may be machined or ground out from the cylindrical housing. Alternatively, a chemical agent such as a solvent may be utilized to remove the existing stator from the cylindrical housing 62.

In the event that an existing cylindrical housing is not to be relined, a new cylindrical housing may be used.

Separate from and independent of the removal of the existing stator from the cylindrical housing of the power section, a stator insert is produced. As seen at box 64, a mandrel having a helical exterior surface is inserted into a mold having an internal cylindrical form. The mandrel is inserted into the mold so that the mandrel is coaxial with the mold.

Thereafter, as shown at box 66, a composite stator insert is formed in the mold in the space between the mandrel and the interior cylindrical wall of the mold. Various composite materials may be utilized for the insert. The insert may include fibers, such as carbon fibers, boron fibers, ceramic fibers, glass fibers, thermoplastic fibers, natural fibers, metallic fibers, fibrous resins and synthetic fibers. The composite materials may be infused or impregnated with a resin. These resins include, but are not limited to, alkyl polyesters, general purpose epoxy, general purpose phenolic urea-formaldehyde compositions, polyurethane, silicone, acrylonitrile-butadiene-styrene (ABS), fluoroplastics (PTFE), polyacetal, polyacrylates, polyacrylonitrile (PAN) and polybutadiene (PBD).

The composite stator insert will cure or otherwise form or harden in the mold. Thereafter, the mandrel is removed from the insert as shown at box 68. A smaller diameter second mandrel is then inserted in the mold. As shown at box 70, an inner lining is formed in the space between the outside surface of the second mandrel and the inner surface of insert.

The outer cylindrical surface of the composite insert has a diameter slightly less than the interior diameter of the cylindrical housing of the power section. As seen at box 75, the composite stator insert is then attached to the cylindrical housing of the power section. This may be accomplished in a number of ways. The composite stator insert may be placed in the cylindrical housing and a bonding agent may be injected or otherwise placed between the composite insert and the cylindrical housing. Alternative measures include placing the bonding agent on the outside surface of the insert and then placing the insert into the housing or mechanically connecting the insert to the housing.

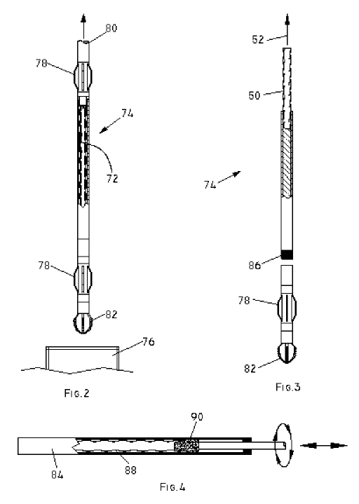

FIGS. 2 through 10 illustrate one preferred embodiment of the sequential process of lining a fluid helical device stator of the present invention as set forth in the flow chart of FIG. 1.

Initially, as seen in FIG. 2, a downhole power section 74 which operates in a subterranean well 76 is raised and brought to the surface. The power section may be connected to and in sequence with various other items and assemblies such as centralizers 78, a motor assembly 80 (only a portion shown in FIG. 2) and a drill bit 82. Over time, the existing stator will wear such as at 72.

The power section 74 includes an external metal cylindrical housing 84 having external threads 86 on each end. The existing helical surface of the stator 88 within the cylindrical housing 84 is removed in a number of ways. FIG. 3 illustrates the power section separated from the other assemblies. The rotor 50 is removed from the power section as illustrated by arrow 52.

As illustrated in FIG. 4, the existing helical surface of the stator may be machined or ground out from the inside of the cylindrical housing as shown by tool 90. Alternatively, a chemical agent, such as a solvent (not shown), may be utilized to remove the existing stator 88 from the cylindrical housing 84. Other possibilities include using a water jet to remove the helical surface. Once this operation is completed, the cylindrical housing 84 has a cylindrical interior surface rather than a helical interior surface. The procedure illustrated in FIGS. 2, 3 and 4 may be performed in the field near the well site.

As a separate procedure, separate and independent from the removal of the existing helical surface of stator 88 from the cylindrical housing 84, a stator insert is formed, as best seen in the sequence of FIGS. 5 through 9. A mold 92 having an interior cylindrical surface, has an inside diameter slightly less than the inside diameter of the cylindrical housing 84. A first mandrel 94 having a helical surface used in the forming or molding process is inserted into the mold 92 and axially centered with centralizers 96.

Thereafter, a fluid material is inserted in the space between the mandrel 94 and the interior wall of the mold 92. The fluid inserted may take many forms including composite materials having fibers such as, but not limited to, carbon fibers, boron fibers, ceramic fibers, glass fibers, thermoplastic fibers, natural fibers, metallic fibers, fibrous resins and synthetic fibers. The composite may also include a resin. The mixture inserted into the mold will harden or cure into a stator insert having a cylindrical exterior and a helical interior.

Thereafter, as shown in FIG. 6, the first mandrel 94 is removed from the mold 92. Thereafter, an optional step is illustrated in FIGS. 7 and 8. A second mandrel 98 is inserted back into the mold 92 and axially centered with centralizers 96. The second mandrel 98 also has a similar helical pattern to the first mandrel, however, it has a slightly smaller diameter than the first mandrel 94. Accordingly, a space is formed between the stator and the second mandrel 98. A lining material 54 is then injected in the space, such as an elastomer. Thereafter, as seen in FIG. 8, the second mandrel 98 is threadably removed from the stator insert within the mold 92. Finally, as best seen in FIG. 9, the formed stator insert 100 is removed from the mold 92.

As a final step, the stator insert 100 is inserted and placed back within the cylindrical housing 84 of the power section as best seen in FIG. 10. The stator insert 100 will be bonded or otherwise secured to the cylindrical housing. This may be accomplished in a number of ways including coating the stator insert with an elastomer 102 as illustrated in FIG. 10. Alternatively, the stator insert may be placed within the cylindrical housing and a bonding agent, such as an elastomer, may be injected in the space between the external surface of the stator housing 100 and the interior of the cylindrical housing 84.

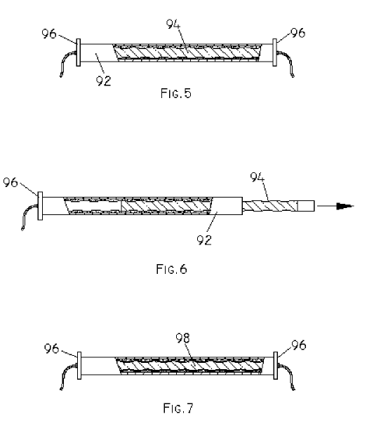

FIGS. 11 and 12 illustrate sectional views of the stator insert 100 after it has been bonded to the cylindrical housing 84 by an elastomer 102. The lining material 54 forms the inside helical surface.

The present invention to reline a fluid helical device stator may also be accomplished in an alternate, preferred procedure.

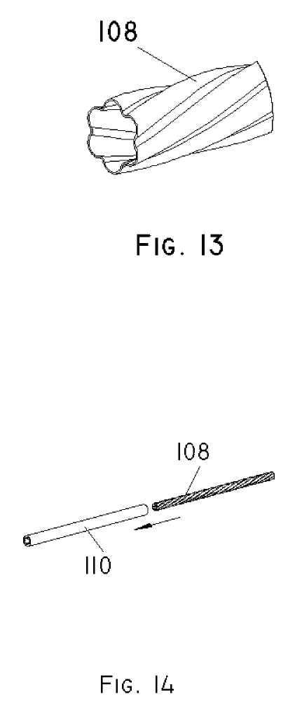

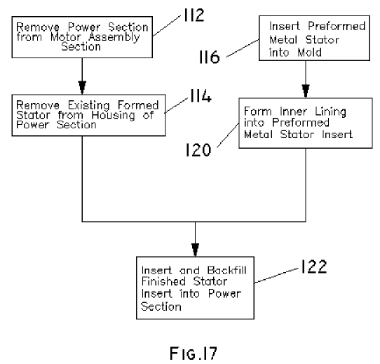

FIG. 17 illustrates a diagrammatic flow chart and FIGS. 15 and 16 illustrate sectional views of an alternate, preferred procedure and device for relining of a helical device.

Again, as previously described and illustrated in the embodiment in FIGS. 2, 3 and 4, the worn existing helical surface of the stator is removed from the cylindrical housing 110 of the power section of the downhole assembly in a number of ways, such as machining, grinding or chemically removing the existing stator as shown at boxes 112 and 114 of FIG. 17.

In the event that an existing cylindrical housing is not to be relined, a new cylindrical housing may be used.

As shown at box 116, a stator insert 108 may be formed from a thin metal cylinder having an outside diameter less than the interior diameter of the cylindrical housing 110. The stator insert 108 has a helical internal surface. The stator insert 108 may be formed in a number of ways, such as metal forming, bending, shaping or other mechanisms which results in a helical internal surface of the metal stator insert.

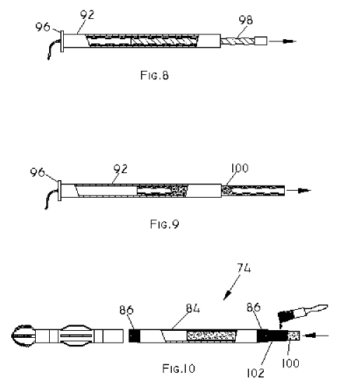

FIG. 13 shows a perspective view of a portion of the stator insert 108.

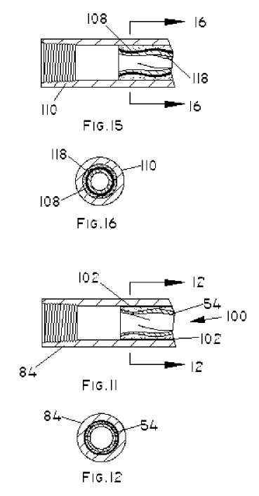

A lining material 118 is then injected or otherwise applied to the inside surface of the metal stator insert 108 as shown at box 120. Thereafter, the metal insert 108 and lining is inserted into the cylindrical housing 110 of the power section and axially centered in the cylindrical housing 110 as shown in FIG. 14. Finally, as shown at box 122 of FIG. 17, a composite material is filled in the space between the metal stator insert 108 and the cylindrical housing 110 of the power section and the metal stator insert 108 is bonded to the cylindrical housing.

Whereas, the present invention has been described in relation to the drawings attached hereto, it should be understood that other and further modifications, apart from those shown or suggested herein, may be made within the spirit and scope of this invention.

What is claimed is:

1. A process for lining a fluid helical device stator, which process comprises:
forming a stator insert having an internal helical surface and an external diameter smaller than a housing for a stator; and
placing said stator insert in said housing and attaching said stator insert to said housing.

2. A process as set forth in claim 1 wherein said step of forming a stator insert includes forming said insert from a thin metal cylinder.

3. A process as set forth in claim 1 wherein said step of forming a stator insert includes molding an insert having a helical internal surface.

4. A process as set forth in claim 1 wherein said insert has an even elastomeric lining.

5. A process for relining a fluid helical device stator, which process comprises:
removing an existing helical surface of a stator from a housing;
inserting a first mandrel in a mold, said mandrel having a helical exterior;
forming a stator insert in said mold; and
inserting and attaching said stator insert in and to said housing.

6. A process for relining a fluid helical device stator as set forth in claim 5 wherein said step of removing said existing helical surface includes machining, grinding out or water jetting said existing helical surface of said stator from said housing.

7. A process for relining a fluid helical device stator as set forth in claim 5 wherein said step of removing said existing helical surface includes chemically removing said existing helical surface from said housing.

8. A process for relining a fluid helical device stator as set forth in claim 5 wherein said housing is cylindrical and includes threaded ends.

9. A process for relining a fluid helical device stator as set forth in claim 5 including an additional step of attaching said stator insert to said power section with an elastomer.

10. A process for relining a fluid helical device stator as set forth in claim 5 including said additional step of removing said first mandrel after forming said stator insert.

11. A process for relining a fluid helical device stator as set forth in claim 5 including the step of lining said stator insert with an elastomer to form an elastomeric inner surface.

12. A process for relining a fluid helical device stator as set forth in claim 11 wherein said elastomeric inner surface is applied by inserting a second mandrel in said mold having a diameter slightly less than said first mandrel.

13. A process for relining a fluid helical device stator as set forth in claim 5 wherein said housing is connected to tubulars used downhole in a subterranean well.

14. A process for relining a fluid helical device stator, which process comprises:
removing an existing helical surface of a stator from a housing;
forming a stator insert from a metal cylinder resulting in a helical internal surface;
lining said helical internal surface with an elastomeric lining;
inserting said stator insert in said housing; and
backfilling and attaching said stator insert to said housing.

15. A process for relining a fluid helical device stator as set forth in claim 14 wherein said step of removing said existing helical surface includes machining, grinding out or water jetting said existing helical surface from said cylindrical housing.

16. A process for relining a fluid helical device stator as set forth in claim 14 wherein said step of removing said existing helical surface includes chemically removing said existing helical surface from said cylindrical housing.

17. A process for relining a fluid helical device stator as set forth in claim 14 wherein a composite is used for backfilling said insert.

18. A process for relining a fluid helical device stator as set forth in claim 14 wherein said step of lining said helical internal surface with an elastomeric lining includes inserting a mandrel having a diameter slightly less than the diameter of said helical internal surface and injecting said elastomer.

19. A process for relining a fluid helical device stator as set forth in claim 14 wherein said housing is connected to tubulars used downhole in a subterranean well.

20. A process for relining a fluid helical device stator as set forth in claim 14 wherein said steps of inserting said stator insert in said housing includes centralizing said insert in said housing.
